(19) United States
(12) Patent Application Publication
(10) Pub. No.: US 2016/0012307 A1
(43) Pub. Date: Jan. 14, 2016

(54) ROAD SIGN RECOGNITION DEVICE

(71) Applicant: DENSO CORPORATION, Kariya-city, Aichi (JP)

(72) Inventor: Taiji Morishita, Obu-shi, Aichi-ken (JP)

(21) Appl. No.: 14/769,067

(22) PCT Filed: Jan. 24, 2014
(86) PCT No.: PCT/JP2014/051499

§ 371 Date: Aug. 19, 2015

(30) Foreign Application Priority Data
Feb. 20, 2013 (JP) 2013-031266

(51) Int. Cl. G06K 9/46; G06K 9/00; B60R 1/00

(52) U.S. Cl. CPC G06K 9/4661; B60R 1/00; G06K 9/00818; B60R 2300/307; B60R 2300/802; G06K 2009/4666

(57) ABSTRACT

In a road sign recognition system, a high luminance region indicating a region with a luminance higher than a predetermined reference luminance in the captured image is extracted (S120, S220), and a vehicle light source that represents a light source derived from the vehicle in the captured image is extracted (S130, S230). Then, a region that matches the vehicle light source in the high luminance region is excluded (S140, S240), and another region excluding the region that matches the vehicle light source in the high luminance region is set as a target region for recognizing the road sign (S150, S250), and the road sign is recognized in the target region. As a result, it is possible to narrow the region of performing the process of recognizing the road sign, thus it is possible to reduce the process load during recognizing the road sign.

### TECHNICAL FIELD

The present invention relates to a road sign recognition device that recognizes a road sign in a captured image.

### BACKGROUND ART

A road sign recognition device that irradiates in the near infrared, searches for a road sign in regions other than black areas that are obviously not a road sign, and recognizes the searched road sign is known (refer to Patent Document 1, for example).

### PRIOR ART

### Patent Document

[Patent Document 1] Japanese Patent Application Laid-Open Publication No. 2006-115624

### DISCLOSURE OF THE INVENTION

### Problems to be Solved by the Invention

However, in the above road sign recognition device, a process of recognizing the road sign is wide is carried out across a wide area, thus there is a problem that the processing load is heavy. Therefore, in view of the above problems, in a road sign recognition device that recognizes a road sign in a captured image, it is an object of the present invention to make it possible to reduce the processing load when recognizing the road sign.

### Means for Solving the Problems

In a road sign recognition device of the present invention made in order to achieve the object, a first means extracts a high luminance region indicating a region with a luminance higher than a predetermined reference luminance in the captured image, and a second means extracts a vehicle light source that represents a light source derived from the vehicle in the captured image. Then, a third means excludes a region that matches the vehicle light source in the high luminance region, and a fourth means sets another region excluding the region that matches the vehicle light source in the high luminance region as a target region for recognizing the road sign, and recognizes road signs in the target region.

According to the road sign recognition device, since it is possible to narrow the region of performing the process of recognizing the road sign, it is possible to reduce the process load during recognizing the road sign. In order to achieve the above object, a computer may be a road sign recognition program for realizing the respective means constituting the road sign recognition device. In addition, the description of each of the claims may be arbitrarily combined as long as possible. In this case, it is possible to exclude some configurations within the scope that can achieve the object of the present invention.

### BRIEF DESCRIPTION OF THE DRAWINGS

FIG. 1 shows a block diagram of a schematic configuration of a road sign recognition system 1;

FIG. 2 shows a flow chart of a road sign recognition process that a CPU 11 of an operation part 10 executes;

FIGS. 3(a) and 3(b) show schematic views of an example of a captured image by imaging parameters for imaging a self-light-emitting type road sign, and an example of a captured image by imaging parameters for imaging a non-self-light-emitting type road sign, respectively; and

FIG. 4 shows an illustration of an example of an extraction area of a road sign.

### MODE FOR CARRYING OUT THE INVENTION

An embodiment according to the present invention will be described with reference to the accompanying drawings.

### Structure of the Present Embodiment

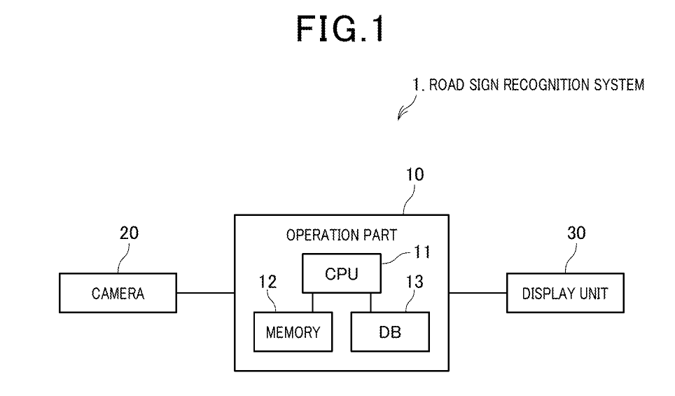

A road sign recognition system 1 to which the present invention is applied is employed on a vehicle traveling on a road such as a passenger car (hereinafter, also referred to as an own vehicle), and has a function of recognizing a road sign not only in a road environment of bright conditions such as daytime, but in a road environment of dark conditions such as nighttime or in a tunnel. In detail, as shown in FIG. 1, the road sign recognition system 1 includes an operation part 10, a camera 20, and a display unit 30.

The camera 20 performs imaging at a predetermined cycle (once every 50 ms, for example) assuming a traveling direction of the own vehicle (usually ahead of the own vehicle) as an imaging range, and sends captured images to the operation part 10. The camera 20 has a function of setting an imaging parameter representing a setting during an image capturing by the camera 20 by a command from the operation part 10.

However, when the imaging parameter is not set by the operation part 10, the camera 20 by itself sets the imaging parameter by an ambient luminance (amount of light or the like to be input to the camera 20), and images by using the imaging parameter. A gain that represents an amplification factor of amplifying a signal generated when a light is sensed by an image sensor which the camera 20 is provided with, or a shutter speed or the like that represents the time to apply light on the image sensor is considered, for example, as the imaging parameter.

The operation part 10 is configured as a known electronic control unit including a CPU 11, a ROM, and a memory 12 such as a RAM. The CPU 11 performs various processes such as a road sign recognition process, which will be described later, following programs (including a road sign recognition program) stored in the memory 12.

Further, the operation part 10 also includes a database (DB) 13. Images of the road signs and values of the images of the road signs quantified by color, luminance, color balance and the like are recorded as a sign data for each road sign in the database 13. The sign data in the database 13 is used to identify the road sign in pattern matching.

Moreover, a map for setting the imaging parameter of the camera 20 is also recorded in the database 13. This map is used in the road sign recognition process, which will be described later.

The display unit 30 is configured as a known display for displaying images generated by the operation part 10. The display unit 30 is disposed at a position visible for a driver of the own vehicle during driving.

### Process of the Present Embodiment

The operation part 10 performs the road sign recognition process that is a process of recognizing the road sign from the captured images. The road sign recognition process begins when a power source of the vehicle is turned on, for example, and is a process performed in a predetermined cycle (once every 100 ms, for example).

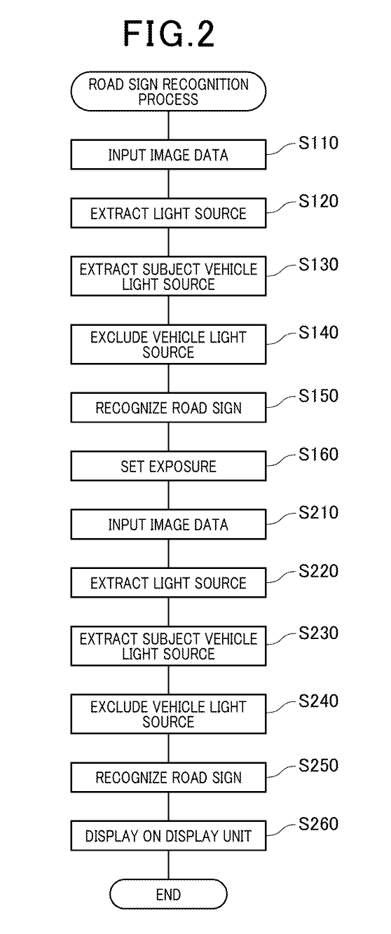

As shown in FIG. 2, the road sign recognition process inputs the images captured by the camera 20 (S110). In this process, the captured images based on the imaging parameter that camera 20 has set by itself are inputted.

Next, an extraction of a light source is performed (S120). In this process, for each pixel constituting the captured image, as compared with a preset reference luminance, a set of pixels having a luminance value higher than the preset reference luminance is extracted as a light source (a high luminance region).

Then, a vehicle light source that represents a light source derived from the vehicle in the captured image is extracted (S130). In this process, the vehicle light source is extracted from the light source extracted in the process of S110. Note that when extracting the vehicle light source, it is not necessary to extract the vehicle light source from the light source extracted in the process of S110, but it may be possible to extract the vehicle light source in any process.

Further, it is possible to employ any process as an extracting process of the vehicle light source. For example, it is possible to use a known process for specifying the vehicle light source based on such as a pair of light sources, a moving direction of the light source, or coordinates of the light source.

Then, the vehicle light source is excluded from the light source (S140). In this process, those identified as vehicle light sources (that match between the light source and the vehicle light source) is excluded among the extracted light sources.

Generally, since the vehicle light source can be detected relatively far away (500 to 1000 m, for example), a possibility that the vehicle light source is recognized correctly is high in a distance intended to recognize the road sign (assumed to be 100 to 200 m, for example). Accordingly, the vehicle light source in this process is accurately removed, and a probability of the road sign in the recognizable range being removed accidentally is low.

Next, recognition of the road sign is performed (S150). In this process, the vehicle light source is excluded from the light source, and the road sign is recognized by performing pattern matching in each remaining region (each target region). During the pattern matching, for each target region, an image pattern of the target region (luminance or color arrangement, etc.) is collated with the respective sign data in the database 13, and a sign for which a certain degree of consistency is obtained or a sign with the most consistency is recognized as a road sign.

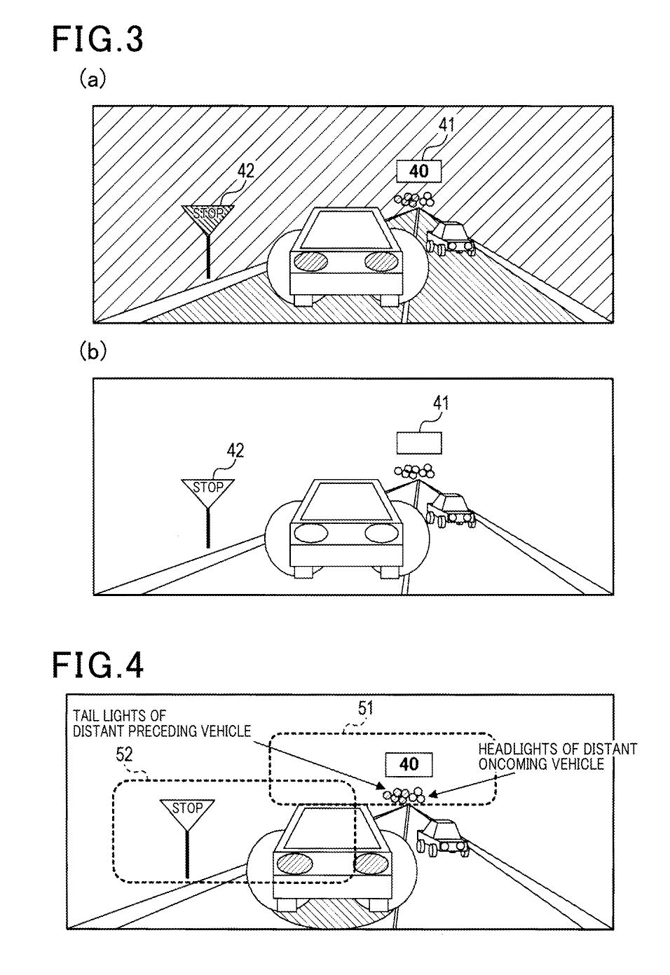

In the processes up to S150, it is considered that a relatively bright road sign in the captured image can be recognized by the captured image according to the imaging parameter set by the camera 20 itself. For example, a captured image shown in FIG. 3(a) is obtained, and a self-light-emitting type road sign 41 can be recognized.

However, it is difficult to recognize a road sign 42 that does not emit light only from the captured image. This is because a luminance is insufficient for recognizing a road sign 42 that does not emit light. Therefore, the imaging parameter is changed (S160) in the present embodiment in order to satisfactorily recognize the road sign 42 that does not emit light.

A captured image obtained by changing the imaging parameter as described below is shown as in FIG. 3(b), for example. That is, the self-light-emitting type road sign 41 is no longer recognized due to a halation, but it is understood that the road sign 42 that does not emit light is satisfactorily recognized.

When setting the imaging parameters, it is set based on luminance of sign existing regions 51, 52 (regions enclosed by broken lines in FIG. 4) that represent regions where the road signs are likely to exist in the captured image that is already obtained, as shown in FIG. 4. However, the imaging parameter is set based on the luminance of areas except for the vehicle light source among the sign existing regions 51, 52. The reason for this is to avoid the influence of luminance of vehicle light sources.

When an average luminance of the sign existing regions 51, 52 (excluding the areas of the vehicle light sources) is determined, for example, the imaging parameter is set by using the map (recorded in the database 13) where the imaging parameters (gain and shutter time) can be uniquely obtained. In this map, it is set so that the gain or the shutter time increases as the average luminance of the sign existing regions (excluding the areas of the vehicle light sources) becomes lower so that a predetermined average luminance and a resolution in the captured image can be obtained.

Here, when a function of recognizing a boundary line (white lines, etc.) that divides a travel range an inside and outside is provided, the sign existing region may be set outside of the boundary line (outside of the travel range).

Next, the captured image captured by the camera 20 using the imaging parameter set by the operation part 10 is inputted (S210). Then, processes similar to the processes described above in S120 to S150 are performed to the captured image (S220 to S250).

Next, a sign similar to the road sign recognized in the processes of S150 and S250 is displayed on the display unit 30 (S310). In this case, the image to be displayed can be an image of the road recorded in the database 13, or another image being recorded corresponding to the recognized road sign.

When such processes are completed, the road sign recognition process ends.

### Effects of the Present Embodiment

In the road sign recognition system 1 described in detail as above, the operation part 10 extracts the high luminance region indicating a region with luminance higher than a predetermined reference luminance in the captured image, and extracts the vehicle light source that represents a light source derived from a vehicle in the captured image. Then, a region that matches the vehicle light source in the high luminance region is excluded, another region excluding the region that matches the vehicle light source among the high luminance region is set as a target region for recognizing the road sign, and the road sign is recognized in this target region.

According to the road sign recognition system 1, since it is possible to narrow the region of performing the process of recognizing the road sign, it is possible to reduce the process load during recognizing the road sign. Further, since the vehicle light source can be detected far from the road sign, the regions regarding the vehicle light source can be excluded earlier if the vehicle light source is detect farther than a distance that can recognize the road sign.

Moreover, the operation part 10 in the road sign recognition system 1 sets the imaging parameters (shutter speed or gain of the camera 20, etc.) that represent the settings when the camera 20 captures the images based on the luminance of the sign existing regions that represent the regions where the road signs are likely to exist in the captured image. Then, the captured image captured by the imaging parameters is obtained, and the road sign is recognized from the captured image captured by the imaging parameters.

According to the road sign recognition system 1, the image capturing is performed again with the imaging parameters suitable for image capturing the target region, and since the road sign is recognized by using the captured image, it is possible to improve accuracy in recognizing the road sign. Furthermore, since the imaging parameters are properly set, an auxiliary device such as a configuration of irradiating infrared rays can be made unnecessary as much as possible, for example.

Further, the operation part 10 in the road sign recognition system 1 sets the imaging parameters based on the luminance of the region excluding the region that matches the vehicle light source among the sign existing regions.

According to the road sign recognition system 1, it is possible to set the imaging parameters without being affected by the luminance of the vehicle light source.

Further, the operation part 10 in the road sign recognition system 1 performs preset information corresponding to the recognized road sign.

According to the road sign recognition system 1, since the information corresponding to the recognized road sign is performed, it is possible to suppress the road sign from oversighting.

Furthermore, the operation part 10 in the road sign recognition system 1 displays the image that represents the recognized road sign on the display unit 30.

According to the road sign recognition system 1, since the image that represents the recognized road sign (the road sign itself or an image that indicates meanings of the road sign by letters, etc.) is displayed, it is possible to satisfactorily inform about the road sign even in the case where it is difficult to recognize the road sign with naked eyes.

### Other Embodiments

The present invention is not interpreted as being limited in any way by the above embodiment. In addition, an aspect to which a part of the configuration of the above embodiment is omitted is also an embodiment of the present invention as long as it can solve the problem. Moreover, an aspect configured by appropriately combining a plurality of embodiments described above is also an embodiment of the present invention. Further, every aspect that can be considered not to deviate from essence of the invention identified only by the words disclosed in claims is also an embodiment of the present invention. Moreover, although reference numbers used in the description of the above embodiments are also appropriately used in the claims, the reference numbers are used for the purpose of facilitating the understanding of the invention in each claim, and are not intended to limit the scope of the invention in any claim.

For example, in the above embodiment, although the same processes as the processes of S120 to S140 are performed in the processes of S220 to S240 to the captured image by the imaging parameters set by the operation part 10, at least any one of the processes of S220 to S240 may be omitted. That is, since it can be said that the captured image obtained before changing the imaging parameters (captured image obtained in the process of S110) and a position of the light source or a position the vehicle light source are substantially the same, the recognition of the road sign may be performed by utilizing the information of these positions by referring to the information on the positions (that is, obtaining at least one of the coordinates of the light source or the coordinates of the vehicle light source).

Further, when recognizing the road sign in the above process, only the process of S150 or the process of S250 may be performed. Furthermore, although the recognized road sign is configured to be displayed on the display unit 30 in the above embodiment, notification by voice or sound etc. may be performed.

### Relationship Between the Configuration of the Present Embodiment and the Configuration of the Invention

The road sign recognition system 1 of the above embodiment corresponds to a road sign recognition device in the present invention, and the camera 20 of the embodiment corresponds to an image capturing section in the present invention. Further, among the processes that operation part 10 performs, the processes of S120 and S220 correspond to the first means for extracting a high-luminance region in the present invention, and the processes S130 and S230 correspond to a second means for extracting a vehicle light source in the present invention.

Furthermore, among the processes of the operation part 10 performs, the processes of S140 and S240 correspond to the third means for excluding a region that matches the vehicle light source in the present invention, and the processes of S150 and S250 correspond to a fourth means for recognizing a road sign in the present invention. Moreover, the process of S160 corresponds to a fifth means for setting an imaging parameter in the present invention, the process of S210 corresponds to a sixth means for obtaining a captured image captured by the imaging parameter in the present invention, and the process of S310 corresponds to a seventh means for performing information in the present invention.

### REFERENCE SIGNS LIST

1 . . . road sign recognition system, 10 . . . operation part, 11 . . . CPU, 12 . . . memory, 13 . . . database, 20 . . . camera, 30 . . . display unit.

1. A road sign recognition device, which is employed on a vehicle, that recognizes a road sign in a captured image, comprising:
a first means for extracting a high luminance region indicating a region with a luminance higher than a predetermined reference luminance in the captured image;
a second means for extracting a vehicle light source that represents a light source derived from the vehicle in the captured image;
a third means for excluding a region that matches the vehicle light source in the high luminance region; and
a fourth means for setting another region excluding the region that matches the vehicle light source in the high luminance region as a target region for recognizing the road sign, and recognizing the road sign in the target region.

2. The road sign recognition device according to claim 1, wherein,
there is provided a fifth means for setting imaging parameters that represent settings when an image capturing section captures the images based on a luminance of sign existing regions that represent regions where the road signs are likely to exist in the captured image; and
a sixth means for obtaining the captured image captured by the imaging parameters; wherein,
the road sign is recognized from the captured image captured by the imaging parameters.

3. The road sign recognition device according to claim 2, wherein,
the fifth means sets the imaging parameters based on the luminance of the region excluding the region that matches the vehicle light source among the sign existing regions.

4. The road sign recognition device according to claim 2, wherein,
there is provided a seventh means for performing preset information corresponding to the recognized road sign.

5. The road sign recognition device according to claim 4, wherein,
the seventh means displays the image that represents the recognized road sign on a display unit.

6. The road sign recognition device according to claim 1, wherein,
the fourth means sets an other region excluding the region that matches the vehicle light source in the high luminance region as the target region for recognizing the road sign.

7. A road sign recognition device characterized in that it:
performs a recognition process of a self-light-emitting type road sign from captured images captured by using a first imaging parameter, and
performs a recognition process of a non-self-light-emitting type road sign from captured images captured by using a second imaging parameter.
